(19) United States
(12) Patent Application Publication
(10) Pub. No.: US 2001/0027419 A1
(43) Pub. Date: Oct. 4, 2001

(54) Methods and apparatus for fulfilling electronic book orders on demand

(76) Inventor: Gerald Keith Sands, Crawfordsville, IN (US)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/814,201

(22) Filed: Mar. 21, 2001

(51) Int. Cl. G06G 1/14; G06F 17/60

(52) U.S. Cl. 705/22

(57) ABSTRACT

The methods and apparatus described herein facilitate the production of “built when ordered” and “direct to reader” books via the Internet or some other wide area network. In operation, book publishers supply electronic book content to printing facilities. In turn, the printing facilities receive book orders from order sources such as retail websites and/or retail stores. Once the book order is received, the book(s) are printed, bound, and packaged using material unique to the order source, and shipped directly to the reader who initiated the book order.

### RELATED APPLICATION

This application claims priority from provisional application Ser. No. 60/192,679 filed Mar. 28, 2000.

### TECHNICAL FIELD

The present invention relates in general to book publishing and, in particular, to methods and apparatus for fulfilling electronic book orders on demand.

### BACKGROUND

Under current business models, books are manufactured in large runs using analog printing processes, and the books are then shipped to the publisher for short term shortage. The books are then shipped to a distribution warehouse, and are later shipped to retailers for ultimate sale to the reader. Unsold books are returned to the publisher. This is the traditional “manufacture, then sell” approach.

The traditional approach includes many intermediate shipping, storage, and handling steps, all of which significantly increase the amount of time and overall costs relating to book manufacturing, distribution and sale. The traditional approach also involves relatively long set up time, and requires that books be printed in relatively large quantities.

### BRIEF DESCRIPTION OF THE DRAWINGS

Features and advantages of the disclosed system will be apparent to those of ordinary skill in the art in view of the detailed description of exemplary embodiments which is made with reference to the drawings, a brief description of which is provided below.

FIG. 1 is high level block diagram of an exemplary wide area network (WAN) communications system capable of employing the teachings of the present invention.

FIG. 2 is a more detailed block diagram of one of the client devices illustrated in FIG. 1.

FIG. 3 is a more detailed block diagram of one of the order sources illustrated in FIG. 1.

FIG. 4 is a more detailed block diagram of the publisher illustrated in FIG. 1.

FIG. 5 is a more detailed block diagram of the printing facility illustrated in FIG. 1.

FIG. 6 is a more detailed block diagram showing one embodiment of the book order server illustrated in FIG. 5.

FIG. 7 is a more detailed block diagram showing another embodiment of the book order server illustrated in FIG. 5.

FIG. 8 is a flowchart of a process for fulfilling electronic book orders on demand.

### DETAILED DESCRIPTION OF EXEMPLARY EMBODIMENTS

In general, the methods and apparatus described herein facilitate the production of “built when ordered” and “direct to reader” books via the Internet or some other wide area network. In operation, book publishers supply electronic book content to printing facilities. In turn, the printing facilities receive book orders from order sources such as retail websites and/or retail stores. A book order may be for a single book, and small number of books, or a large number of books. Once a minimum number of books are ordered, the book(s) (preferably including bodies and covers) are printed, bound, and packaged using material unique to the order source, and shipped directly to the reader(s) who initiated the book order(s).

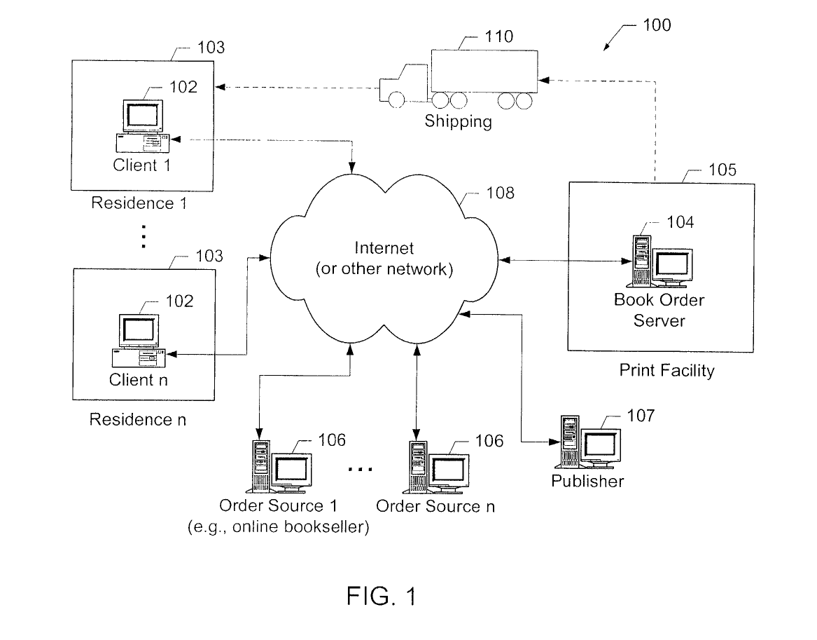

A high level block diagram of an exemplary wide area network (WAN) communications system 100 capable of employing the teachings of the present invention is illustrated in FIG. 1. Typically, the system 100 includes a plurality of client devices 102, one or more book order servers 104, multiple order sources 106, and one or more publishers 107. Each of these devices may communicate with each other via a connection to the Internet or some other wide area network 108.

Typically, each client device 102 is located in a residence 103 such as a person's home or apartment. Preferably, each residence has a different destination address (e.g. 1234 Elm Street, Chicago, Ill. 60606). As used herein, a destination address is any address used by a physical mail delivery service such as the U.S. Postal Service, Federal Express, United Postal Service, etc. Each book order server 104 is preferably located in a printing facility 105. A printing facility 105 preferably includes a plurality of high-end printers, such as a bank of digital printing presses, offset printing presses, book presses, etc., as described in detail below. Each print facility 105 has a destination address which is different from the residential addresses. An order source 106 is preferably an online bookseller such as Amazon.com, and a publisher 107 is preferably an established publishing entity such as West Publishing.

Typically, servers 104, 106, 107 store a plurality of files, programs, and/or web pages for use by the client devices 102. One server 104, 106, 107 may handle requests from a large number of clients 102.

Accordingly, each server 104, 106, 107 is typically a high end computer with a large storage capacity, one or more fast microprocessors, and one or more high speed network connections. Conversely, relative to a typical server 104, 106, 107, each client device 102 typically includes less storage capacity, a single microprocessor, and a single network connection.

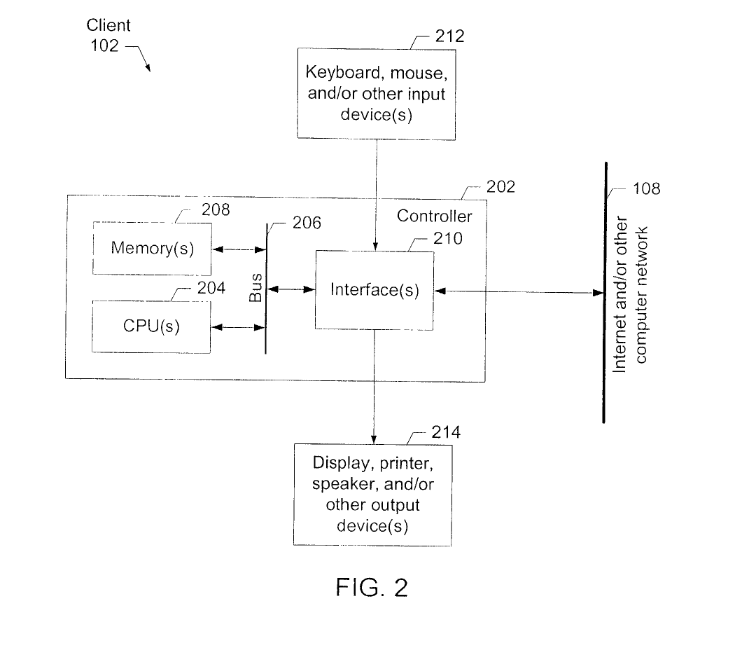

A more detailed block diagram of a client device 102 is illustrated in FIG. 2. The client device may be a personal computer (PC), a personal digital assistant (PDA), an Internet appliance, a cellular telephone, or any other communication device. The client 102 includes a controller 202 which preferably includes a central processing unit 204 electrically coupled by an address/data bus 206 to a memory device 208 and an interface circuit 210.

The CPU 204 may be any type of well known CPU, such as an Intel PentiumTM processor. The memory device 208 preferably includes volatile memory and non-volatile memory. Preferably, the memory device 208 stores a software program that interacts with the order source 106 as described below. This program may be executed by the CPU 204 in a well known manner. The memory device 208 may also store digital data indicative of documents, files, programs, web pages, etc. retrieved from a server 104, 106, 107 and/or loaded via an input device 212.

The interface circuit 210 may be implemented using any type of well known interface standard, such as an Ethernet interface and/or a Universal Serial Bus (USB) interface. One or more input devices 212 may be connected to the interface circuit 210 for entering data and commands into the controller 202. For example, the input device 212 may be a keyboard, mouse, touch screen, track pad, track ball, isopoint, and/or a voice recognition system.

One or more displays, printers, speakers, and/or other output devices 214 may also be connected to the controller 202 via the interface circuit 210. The display 214 may be cathode ray tube (CRTs), liquid crystal displays (LCDs), or any other type of display. The display 214 generates visual displays of data generated during operation of the client 102. The display 214 is typically used to display web pages received from the order source 106. The visual displays may include prompts for human operator input, run time statistics, calculated values, detected data, etc.

The client 102 may also exchange data with other devices via a connection to the network 108. The network connection may be any type of network connection, such as an Ethernet connection, digital subscriber line (DSL), telephone line, coaxial cable, etc. Users of the system 100 may be required to register with the order source 106. In such an instance, each user may choose a user identifier and a password which may be required for the activation of services. The user identifier and password may be passed across the Internet 108 using encryption built into the user's browser. Alternatively, the user identifier and/or password may be assigned by the order source 106 or any other device.

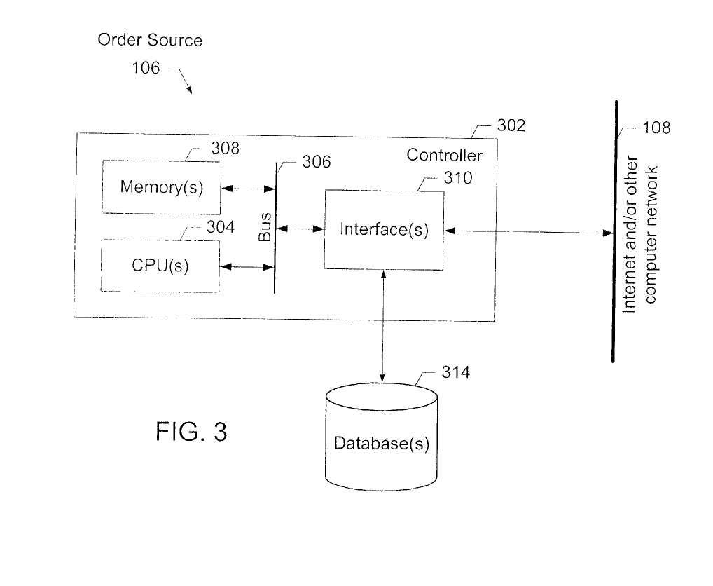

A more detailed block diagram of an order source 106 is illustrated in FIG. 3. Like the client device 102, the controller 302 in the order source 106 preferably includes a central processing unit 304 electrically coupled by an address/data bus 306 to a memory device 308 and a network interface circuit 310. However, the order source controller 302 is typically more powerful than the client controller 202. Again, the CPU 304 may be any type of well known CPU, such as an Intel PentiumTM processor, and the memory device 308 preferably includes volatile memory and non-volatile memory. Preferably, the memory device 308 stores a software program that implements all or part of the method described below. This program may be executed by the CPU 304 in a well known manner. However, some of the steps described in the method below may be performed manually or without the use of the order source 106. The memory device 308 and/or a separate database 314 also store files, programs, web pages, etc. for use by the client devices 102 and/or other servers 104, 107.

The order source 106 may exchange data with other devices via a connection to the network 108. The network interface circuit 310 may be implemented using any data transceiver, such as an Ethernet transceiver. The network 108 may be any type of network, such as a local area network (LAN) and/or the Internet.

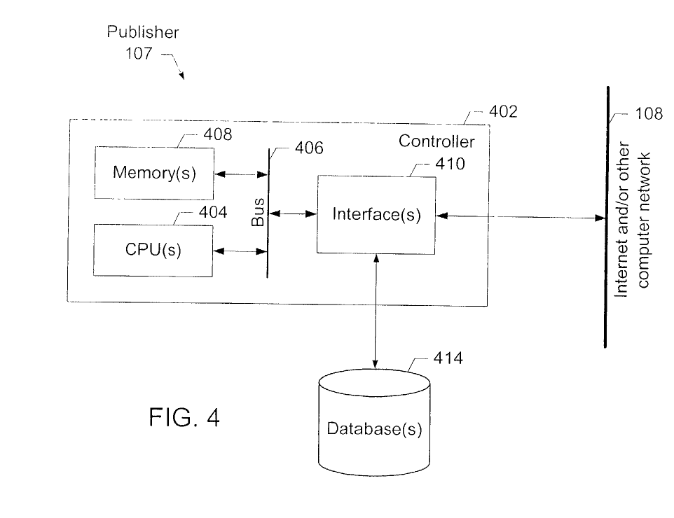

A more detailed block diagram of a publisher 107 is illustrated in FIG. 4. Like the client device 102 and the order source 106, a controller 402 in the publisher 107 preferably includes a central processing unit 404 electrically coupled by an address/data bus 406 to a memory device 408 and a network interface circuit 410. Again, the CPU 404 may be any type of well known CPU, such as an Intel Pentium TM processor, and the memory device 408 preferably includes volatile memory and non-volatile memory. Preferably, the memory device 408 stores a software program that implements all or part of the method described below. This program may be executed by the CPU 404 in a well known manner. However, some of the steps described in the method below may be performed manually or without the use of the publisher 107. The memory device 408 and/or a separate database 414 also store files, programs, web pages, etc. for use by the client devices 102 and/or other servers 104, 106. The publisher 107 also exchanges data with other devices via a connection to the network 108.

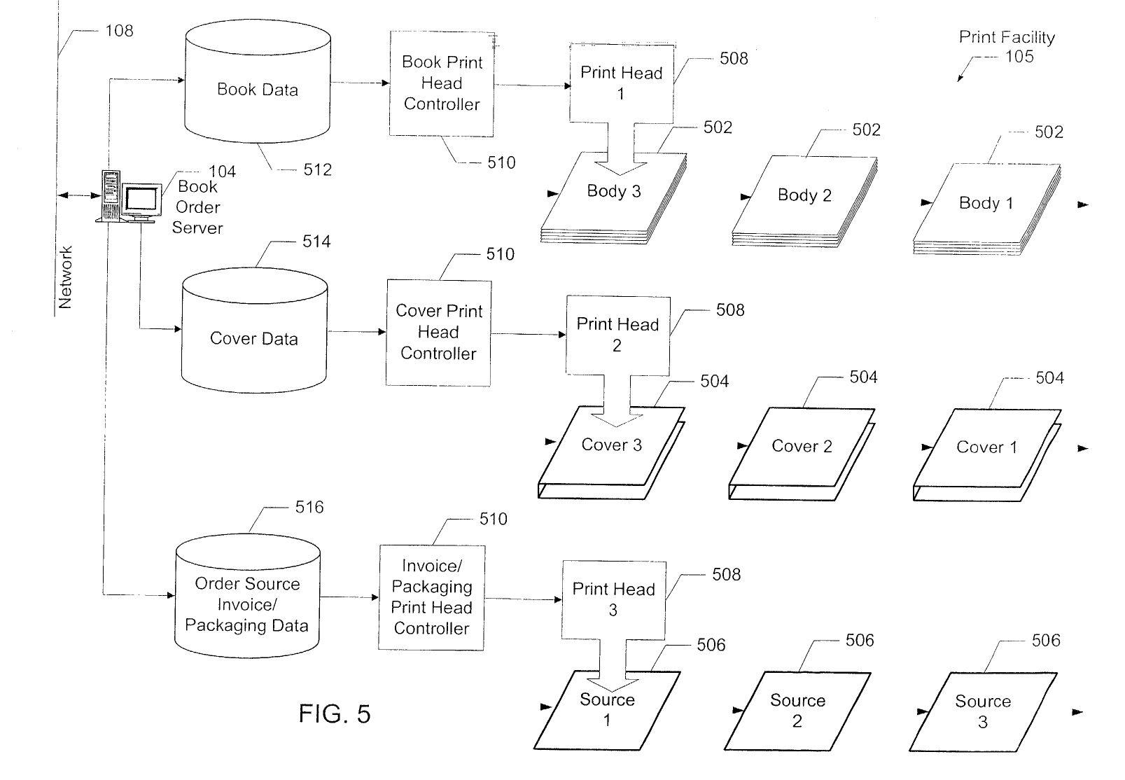

A more detailed block diagram of a print facility 105, providing a preferred environment of use, is illustrated in FIG. 5. The print facility 105 preferably prints a plurality of book bodies 502, a plurality of corresponding book covers 504, and a plurality of corresponding order source material 506. Book bodies 502 include the printed pages of a book. Book covers 504 preferably include a sturdy front, back, and spine for the book bodies 502. In the preferred embodiment, book covers 504 are printed to correspond to an associated book body 502. Source material preferably includes an invoice and/or a mailer. The invoice and/or the mailer may be customized to designate the order source 106 (e.g., branding based on order source). Preferably, the invoice is printed on standard stock. However, the mailer may be made of a heavier material. In one embodiment, a mailing label is printed and attached to the mailer in a well known manner. However, the mailing label is customized to reflect the order source brand as described in detail below.

The book bodies 502 may be printed separate from the corresponding book covers 504 as shown, or the book bodies 502 and the book covers 504 may be printed using the same process. Similarly, order source material 506 may be printed separately as shown, or order source material 506 may be printed by the same print head as the book bodies 502 and/or book covers 504. In the event that the book bodies 502, corresponding book covers 504, and/or corresponding order source material 506 are printed separately, a bar code label or other tracking mechanism may be used to match a particular book body 502 to a particular book cover 504 to create a finished book. Similarly, a bar code label or other tracking mechanism may be used to match a finished book to a particular combination of source materials 506 to create a mailable package.

The book bodies 502 are printed using a print head 508. The print head 508 is preferably part of a well known digital printing system such as a digital press (e.g., a Xeikon DCP-1 digital press). However, a person of ordinary skill in the art will readily appreciate that any printing system may be used. The print head 508 is controlled by a print head controller 510. The print head controller 510 typically includes a microprocessor and program memory adapted to receive digital data 512 representing the text and/or images associated with a particular book (or other publication). This book data 512 is preferably stored in a computer readable memory in a well known manner. The print head controller 510 preferably converts the book data 512 into printing commands for the print head 508 in a well known manner. For example, the print head controller 510 may cause the print head 508 to force drops of ink through a controlled grid of nozzles to produce a hard copy of a digital image on a page. As additional copies of the desired image are produced, each page is mechanically moved away from the print head 508 as is well known. Typically, the digital image is raster image processed before it is stored in memory.

Similarly, each book cover 504 is preferably printed using a print head 508 which is connected to a digital printing system. As discussed above, this print head 508 may be the same print head 508 used to produce book bodies 502. The cover print head 508 is also controlled by a print head controller 510. This print head controller 510 may be the same print head controller 510 used to produce book bodies 502 or a separate print head controller 510. As with the body print head controller 510, the cover print head controller 510 typically includes a microprocessor and program memory adapted to receive digital data 514 representing the text and/or images associated with a particular book cover. Again, this cover data 514 is preferably stored in a computer readable memory, and the print head controller 510 preferably converts the cover data 514 into printing commands for the print head 508 in a well known manner.

Similarly, each piece of order source material 506 is preferably printed using a print head 508 which is connected to a digital printing system. As discussed above, this print head 508 may be dedicated or shared. The order source material print head 508 is also controlled by a print head controller 510. Again, this print head controller 510 may be dedicated or shared. As with the other print head controllers 510, the order source material print head controller 510 typically includes a microprocessor and program memory adapted to receive digital data 516 representing the text and/or images associated with an invoice or a package. Again, this source specific data 516 is preferably stored in a computer readable memory, and the print head controller 510 preferably converts the source specific data 516 into printing commands for the print head 508 in a well known manner.

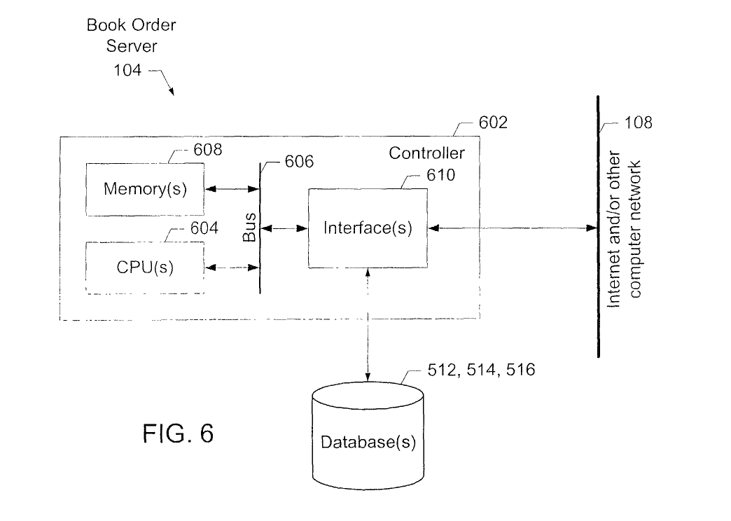

The book data 512, cover data 514, and order source specific data 516 are preferably received from the network 108 by the book order server 104. A detailed block diagram of one embodiment of the book order server 104 is illustrated in FIG. 6. Like the client device 102, the order source 106, and the publisher 107, a controller 602 in the book order server 104 preferably includes a central processing unit 604 electrically coupled by an address/data bus 606 to a memory device 608 and a network interface circuit 610. Again, the CPU 604 may be any type of well known CPU, such as an Intel Pentium TM processor, and the memory device 608 preferably includes volatile memory and non-volatile memory. Preferably, the memory device 608 stores a software program that implements all or part of the method described below. This program may be executed by the CPU 604 in a well known manner. However, some of the steps described in the method below may be performed manually or without the use of the book order server 104. The memory device 608 and/or a separate database also store the book data 512, cover data 514, order source specific data 516, other files, programs, web pages, etc. The book order server 104 also exchanges data with other devices via a connection to the network 108.

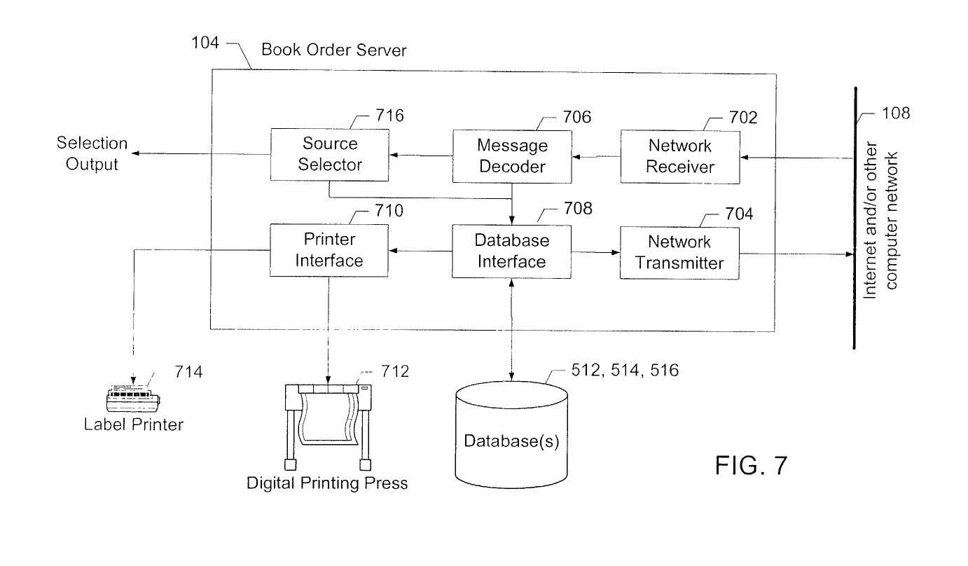

A more detailed block diagram of another embodiment of the book order server 104 is illustrated in FIG. 7. In this embodiment, the book order server 104 includes a plurality of interconnected modules 702-716. Each of the modules may be implemented by a microprocessor executing software instructions and/or conventional electronic circuitry. In addition, a person of ordinary skill in the art will readily appreciate that certain modules may be combined or divided according to customary design constraints.

For the purpose of receiving book data 512, cover data 514, order source specific data 516, and other data, the book order server 104 includes a network receiver 702. The network receiver 402 is operatively coupled to the network 108 in a well know manner. For example, the network receiver 402 may be an Ethernet interface circuit electrically coupled to the Internet via an Ethernet cable.

For the purpose of transmitting data to other devices coupled to the network 108, the book order server 104 includes a network transmitter 704. The network transmitter 704 is operatively coupled to the network 108 in a well know manner. For example, the network transmitter 704 may also be an Ethernet interface circuit electrically coupled to the Internet via an Ethernet cable.

For the purpose of decoding received messages, the book order server 104 includes a message decoder 706. The message decoder 706 is operatively coupled to the network receiver 702. The message decoder 706 interprets book order data received via the network receiver 702, the book order data includes one or more book identifiers, an order source identifier, a destination address, and/or financial transaction information. The book identifier may be an International Standard Book Number (ISBN) or any other identifier. The order source identifier may be a retail website's name, a retail store's name, an Internet address, or any other identifier. The financial transaction information may be a credit card number, a debit card number, digital cash, or any other financial transaction information. Preferably, the destination address is associated with a residence, and the financial transaction information is associated with a person who resides at that residence.

For the purpose of interfacing with the database(s) 512, 514, 516, the book order server 104 preferably includes a database interface module 708. The database interface module 708 is in communication with the database 314. Preferably, the database interface module 708 is operatively coupled to the message decoder 706 and the network transmitter 704. In operation, the database interface module 708 retrieves the book data 512, the cover data 514, the source specific data 516, customer data, financial records, and/or other data from the database(s). Preferably, the book data 512 and/or the cover data 514 are stored in the database(s) in association with an International Standard Book Number (ISBN).

For the purpose of transmitting book content and/or a destination address to a printer, the book order server 104 includes a printer interface module 710. The printer interface module 710 is operatively coupled to the database interface module 708. The printer interface module 710 may interface with one or more printers 712. For example, the printer interface module 710 may send book content to a digital printing press 712 and a destination address to a label printer 714.

For the purpose of selecting order source specific items and data, the book order server 104 includes a source selection module 716. Preferably, the source selection module 716 is operatively coupled to the message decoder 706. The source selection module 716 may select order source specific packaging, logos, invoice styles, pricing, etc. based on the order source identifier. For example, the source selection module 716 may output a message to an operator to select package style #ABC for order number #123 because order #123 originated with vendor ABC. As a result, orders from a first retail website appear to come from that retail website while orders from a second retail website receive different packaging and appear to come from that retail website, despite the fact that both orders were actually shipped from the same printing facility 105. In another embodiment, the orders are automatically packaged in the appropriate mailers. In addition, order source specific logos may be printed on mailing labels, packaging, invoices etc.; order source specific pricing may be used; order source specific invoice stock or styles may be used; etc.

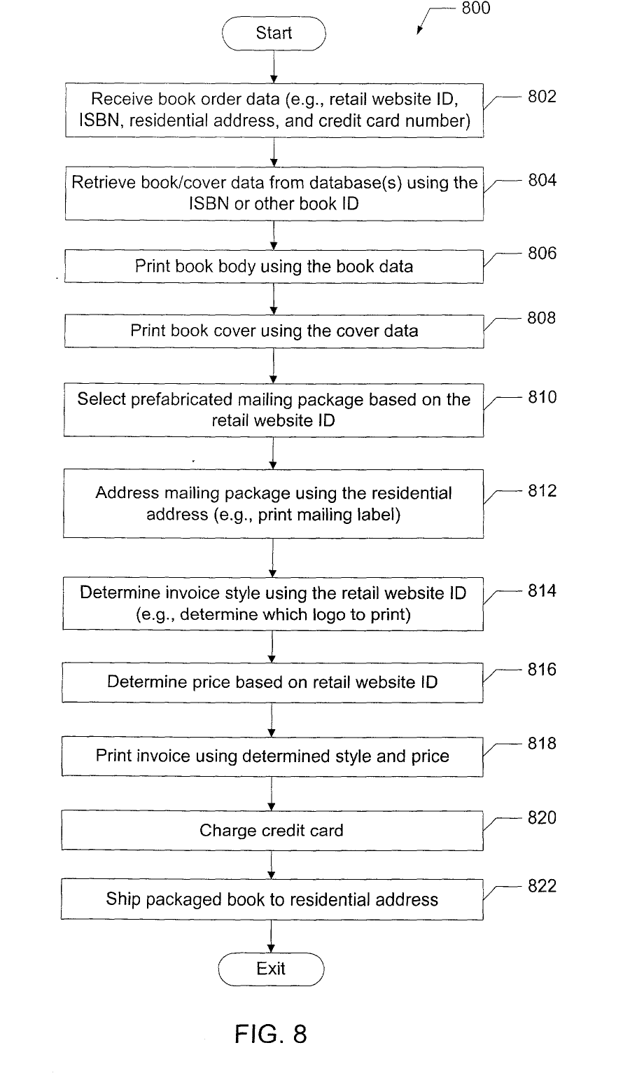

A flowchart of a process 800 for fulfilling electronic book orders on demand is illustrated in FIG. 8. Preferably, the process 800 is embodied in a software program which is stored in the book order server memory 608 and executed by the book order server CPU 604 in a well known manner. However, some or all of the steps of the process 800 may be performed manually and/or by another device. Although the process 800 is described with reference to the flowchart illustrated in FIG. 8, a person of ordinary skill in the art will readily appreciate that many other methods of performing the acts associated with process 800 may be used. For example, the order of many of the steps may be changed without departing from the scope or spirit of the present invention. In addition, many of the steps described herein are optional.

Generally, the process 800 facilitates the production of “built when ordered” and “direct to reader” books via the Internet or some other wide area network. In operation, a book publisher 107 supplies electronic book content to a printing facility 105. In turn, the printing facility 105 receives a book order from an order source 106 such as an online bookseller. The book order may be for any number of books. Once the book order is received, the book(s) are printed, bound, and packaged using material unique to the order source 106, and shipped directly to the reader who initiated the book order.

The process 800 begins when book order data is received at the book order server 104 (step 802). The book order data preferably includes a destination address, financial transaction information, and one or more book identifiers. In addition, the book order data includes an order source identifier. The financial transaction information may be a credit card number, a debit card number, digital cash, or any other financial transaction information. Preferably, the destination address is associated with a residence, and the financial transaction information is associated with a person who resides at that residence. However, in an alternate embodiment, the “send-to” and “bill-to” addresses may be different. For example, a father may order a book for his son as a gift. In such an instance, one person's credit card is charged even though another person receives the book.

The book order data may be generated at a website which sells books in response to the website receiving an order from a customer. For example, a customer may enter his residential address, his credit card number, and a book selection at a website such as Amazon.com in a well known manner. The website then adds the order source identifier and transmits the book order data to the book order server 104. The order source identifier may be a retail website's name, a retail store's name, an Internet address, or any other identifier. The order source identifier is used to make the packaged book order appear to the customer as if it came from the website instead of the printing facility 105 which may handle requests from a plurality of order sources 106. This customization of the book package may include the price, the invoice, and/or the package as described in detail below.

Once the book order data is received at the book order server 104, the book order server 104 retrieves book data 512 and/or cover data 514 from the database(s) using the book identifier (step 804). For example, the book data 512 may represent the text and/or images associated with a particular ISBN. Once the book data 512 is retrieved, the book order server 104 prints the book body (step 806) and optionally the book cover (step 808). The book body and the book cover may printed on the same printer or on different printers.

The completed book is then placed in a mailing package. The package may be a prefabricated package which is selected based on the order source identifier (step 810). For example, Amazon.com may have brown cardboard mailers which include the Amazon.com logo, while Barnes and Noble uses white paper mailers with the Barnes and Noble logo. Alternatively, the book order server 104 may retrieve print data based on the order source identifier which is used to print an order source specific mailer. The mailer is then addressed using the destination address (step 812). Preferably, the mailer is addressed by printing a mailing label at a label printer 714 and affixing the label to the package. Alternatively, the address may be printed directly on the packaging.

The book order server 104 may also determine a particular invoice style based on the order source identifier (step 814). Like the mailing package, the invoice may be prefabricated or completely printed on the fly. When printing the invoice, the book order server 104 typically includes the price of the ordered book(s). This price may be retrieved from a database based on the order source identifier (step 816) or the current pricing information for this retailer may be supplied with the book order data. Once the correct invoice stock (in the case of prefabricated invoices) has been selected and the appropriate invoice data is gathered, the book order server 104 prints the invoice on a printer (step 818). The invoice is preferably included in the mailing package with the book.

Finally, the book order server 104 may charge the reader's credit card (step 820) and ship the packaged book directly to the reader's residence (step 822). Alternatively, the order source may charge the reader's credit card. In such an instance, the book order data need not include the reader's financial transaction information. Regardless of who takes the reader's book order or processes the reader's financial transaction information, the reader's book may be printed after it is ordered and shipped in a manner that gives the reader the illusion that the book came from the order source 106, not the print facility 105.

In an alternate embodiment, the “send-to” and “bill-to” addresses may be different. For example, a father may order a book for his son as a gift. In such an instance, one person's credit card is charged even though another person receives the book.

In summary, persons of ordinary skill in the art will readily appreciate that a method and apparatus for fulfilling electronic book orders on demand by shipping books directly from a printing facility to a reader has been provided. Systems implementing the teachings described herein will benefit from reduced warehousing costs, reduced shipping costs, reduced handling costs, and reduced scrap costs.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description, but rather by the claims appended hereto.

What is claimed is:

1. A method of fulfilling book orders, the method comprising the steps of:
receiving first book order data from a first website server, the first book order data including a first website identifier, a first book identifier, and a first destination address;
retrieving first book content from a first database based on the first book identifier;
printing a first book using the first book content;
packaging the first book in a first mailer instead of a second mailer based on the first website identifier, the first mailer including a first source identifier;
addressing the first mailer using the first destination address;
receiving second book order data from a second website server, the second book order data including a second website identifier, a second book identifier, and a second destination address;
retrieving second book content from a second database based on the second book identifier;
printing a second book using the second book content;
packaging the second book in the second mailer instead of the first mailer based on the second website identifier, the second mailer including a second source identifier, the second source identifier being visibly different than the first source identifier; and
addressing the second mailer using the second destination address.

2. A method as defined in claim 1, wherein the first database comprises the second database.

3. A method as defined in claim 1, wherein the step of printing a first book using the first book content comprises the step of printing the first book at a digital printing press and the step of printing a second book using the second book content comprises the step of printing the second book at the digital printing press.

4. A method as defined by claim 3, wherein the step of printing the second book at the digital printing press occurs chronologically after the step of printing the first book at the digital printing press without printing a third book chronologically in-between the step of printing the first book and the step of printing the second book.

5. A method as defined in claim 1, wherein the first source identifier comprises a first trademark and the second source identifier comprises a second trademark, the first trademark being different than the second trademark.

6. A method as defined in claim 1, wherein the step of receiving first book order data from a first website server comprises the step of receiving first book order data from a first Internet domain and the step of receiving second book order data from a second website server comprises the step of receiving second book order data from a second Internet domain, the first Internet domain being different than the second Internet domain.

7. A method as defined in claim 1, wherein the step of printing a first book comprises the step of printing the first book at a printing facility located at a source address, the method further comprising the step of shipping the first book from the source address to the first destination address without labeling the first book with an intermediate address, the intermediate address being different than the first destination address, the intermediate address being different than the source address.

8. A method as defined in claim 1, further comprising the steps of printing a first invoice and printing a second invoice, the first invoice being included with the first book, the second invoice being included with the second book, the first invoice including the first source identifier, the second invoice including the second source identifier.

9. A method of fulfilling book orders, the method comprising the steps of:
receiving a book identifier at a book order fulfillment server via a wide area network;
receiving a destination address at the book order fulfillment server via the wide area network;
receiving payment information at the book order fulfillment server via the wide area network;
printing a first book identified by the book identifier at a printing press after the steps of receiving the book identifier, receiving the destination address, and receiving the payment information, the printing press being located at a print facility;
charging a predetermined monetary amount associated with the book identifier to an account identified by the payment information; and
addressing the first book at the print facility for direct shipment from the print facility to the destination address.

10. A method as defined in claim 9, wherein the step of receiving payment information comprises the step of receiving payment information associated with a person living at the destination address.

11. A method as defined in claim 9, wherein the step of receiving payment information comprises the step of receiving payment information associated with a retail website.

12. A method as defined in claim 9, further comprising the step of printing a second book before the step of receiving the book identifier, receiving the destination address and receiving the payment information.

13. A method as defined in claim 9, wherein the step of printing a first book comprises the step of printing the first book at a digital printing press.

14. A printing facility comprising:
a network receiver;
a plurality of printers;
a database; and
a book order server operatively coupled to the network receiver, the plurality of printers, and the database, the book order server including a processor and a digital memory operatively coupled to the processor, the digital memory being structured to cause the processor to:
(i) receive and decode book order data via the network receiver, the book order data including a website identifier, a book identifier, and a destination address;
(ii) retrieve book content from the database based on the book identifier;
(iii) print a book using the book content on at least one of the plurality of printers;
(iv) select logo data indicative of a website logo, the logo data being selected based on the website identifier;
(v) print the website logo on at least one of an invoice, a mailing label, and a mailing package; and
(vi) print the destination address on at least one of the invoice, the mailing label, and the mailing package.

15. A printing facility as defined in claim 14, wherein the network receiver comprises an Ethernet receiver structured to receive TCP/IP data from the Internet.

16. A printing facility as defined in claim 14, wherein the plurality of printers comprises a plurality of digital printing presses.

17. A printing facility as defined in claim 14, wherein the digital memory is structured to cause the processor to receive and decode the book identifier in the form of an International Standard Book Number (ISBN).

18. A book order server comprising:
a network receiver;
a message decoder operatively coupled to the receiver, the message decoder being structured to interpret book order data received via the network receiver, the book order data uniquely identifying an International Standard Book Number (ISBN) and a destination address;
a database interface module operatively coupled to the message decoder;
a database operatively coupled to the database interface module, the database interface module being structured to retrieve book content from the database based on the International Standard Book Number (ISBN); and
a printer interface module operatively coupled to the database interface module, the printer interface module being structured to transmit the book content to a first digital printing press to print a book, the printer interface module being structured to transmit the destination address to a second printer.

19. A book order server as defined in claim 18, wherein the first printer comprises the second printer.

20. A book order server as defined in claim 18, further comprising a source selection module operatively coupled to the message decoder, the source selection module facilitating selection of book mailing packaging unique to an order source identified by the book order data.

21. A book order server as defined in claim 18, wherein the database interface module is structured to retrieve a logo and the printer interface module is structured to transmit the logo to the second printer.

22. A book order server as defined in claim 18, wherein the message decoder is structured to process a personal credit card transaction associated with a person living at the destination address.
